(19) United States
(12) Patent Application Publication
(10) Pub. No.: US 2005/0215259 A1
(43) Pub. Date: Sep. 29, 2005

(54) METHOD FOR RECEIVING FREE WIRELESS PUBLIC BROADCAST SERVICES WITH A MOBILE STATION

(76) Inventor: Steven D. Cheng, San Diego, CA (US)

Correspondence Address: NORTH AMERICA INTERNATIONAL PATENT OFFICE (NAIPC), P.O. BOX 506, MERRIFIELD, VA, 22116, US

(21) Appl. No.: 10/708,798

(22) Filed: Mar. 26, 2004

(51) Int. Cl. H04Q 7/20; H04M 1/00; H04B 1/38

(52) U.S. Cl. 455/452.2; 455/558

(57) ABSTRACT

A method for receiving public broadcast services with a wireless device compatible with the Global System for Mobile communications (GSM) protocol is disclosed. The method includes performing a radio frequency (RF) scan on all frequencies in at least one predetermined frequency band to identify all possible Broadcast Control Channels (BCCHs), measuring Received Signal Strength Indicator (RSSI) levels for each BCCH, and sorting the BCCHs according to the corresponding RSSI levels. The wireless device next selects a BCCH having a strongest average RSSI level and camps on a cell corresponding to the selected BCCH. The wireless device is then able to receive GSM public broadcast services from a mobile phone network operating the selected BCCH irrespective of whether the wireless device subscribes to the mobile phone network.

### BACKGROUND OF INVENTION

1. Field of the Invention

The present invention relates to wireless public broadcast services, and more specifically, to a method for allowing current Global System for Mobile communications (GSM) mobile station users to receive free wireless public broadcast services.

2. Description of the Prior Art

In many mobile phone networks, there are several kinds of information broadcast by base stations that can be used in a free access manner by mobile stations. This free information includes information broadcast from the Short Message Service (SMS) channel, system information broadcast from Broadcast Control Channels (BCCHs), and Received Signal Strength Indicator (RSSI) level measurements on each targeted channel.

Currently, for broadcasting SMS services, some mobile phone network operators require mobile users to subscribe to different kinds of broadcasting information, while other operators provide free public information broadcasting services.

Some of the information provided by the mobile phone network operators is location specific. That is, only users near a designated location will receive specific broadcasts intended for that location. Part of the system information that is related directly to the location service is the Mobile Country Code (MCC), the Mobile Network Code (MNC), and the Location Area Code (LAC). Since each base station uses a unique identification, by decoding the combination of the MCC, MNC, and LAC, we can roughly estimate the location of the mobile station.

It is also possible to use RSSI level measurements to further refine the estimation of the mobile station location. The data derived from the MCC, MNC, LAC, and the RSSI measurement can also be translated into GPS related co-ordination information.

In order for the information described above to be available to the mobile station, the current GSM specification assumes that a Subscriber Identity Module (SIM) card is ready.

Please refer to FIG. 1. FIG. 1 is a GSM Public Line Mobile Network (PLMN) selection state diagram 10 according to the prior art. The PLMN selection state diagram 10 is taken from the 3GPP specification TS 03.22 version 6.3.0, which is incorporated in its entirety herein by reference. For convenience, the PLMN selection state diagram 10 has been divided into two parts: section 20 and section 30. Section 20 begins with a null state 22 in which the mobile station is powered off. When the mobile station is switched on and contains a valid SIM card, the flow moves to state 24. State 24 determines whether there is a Registered PLMN (RPLMN). If so, the flow moves to indicator arrow H in section 30. If there is no RPLMN, the flow moves to indicator arrow A in section 30. If the mobile station is powered on and either does not contain a SIM card or does not contain a valid SIM card, the flow moves to state 26.

Unfortunately, at this point the state diagram can advance no further unless a valid SIM card is inserted, in which case the flow will advance to state 24. This means that even if a user has a working GSM compatible mobile station, without a valid SIM card, the user is still not able to receive free information broadcast by base stations.

### SUMMARY OF INVENTION

It is therefore an objective of the claimed invention to utilize a current GSM mobile station or a special purpose wireless device to access free wireless information without adversely affecting the existing GSM protocols in order to solve the above-mentioned problems.

According to the claimed invention, a method for receiving public broadcast services with a wireless device compatible with the Global System for Mobile communications (GSM) protocol is disclosed. The method includes performing a radio frequency (RF) scan on all frequencies in at least one predetermined frequency band to identify all possible Broadcast Control Channels (BCCHs), measuring Received Signal Strength Indicator (RSSI) levels for each BCCH, and sorting the BCCHs according to the corresponding RSSI levels. The wireless device next selects a BCCH having a strongest average RSSI level and camps on a cell corresponding to the selected BCCH. The wireless device is then able to receive GSM public broadcast services from a mobile phone network operating the selected BCCH irrespective of whether the wireless device subscribes to the mobile phone network.

It is an advantage of the claimed invention that the wireless device can receive the GSM public broadcast services from any participating mobile phone network operator, even if the user of the wireless device does not subscribe to the mobile phone network. In this way, the user of the wireless device can receive important location specific GSM public broadcasts no matter where he travels without having to subscribe to additional mobile phone networks.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a GSM Public Line Mobile Network (PLMN) selection state diagram according to the prior art.

FIG. 2 is a state diagram according to the present invention, and is a modification of the GSM PLMN selection state diagram shown in FIG. 1.

FIG. 3 contains a state diagram showing how special purpose wireless devices can take advantage of the free public information broadcasting services offered by mobile phone network operators.

### DETAILED DESCRIPTION

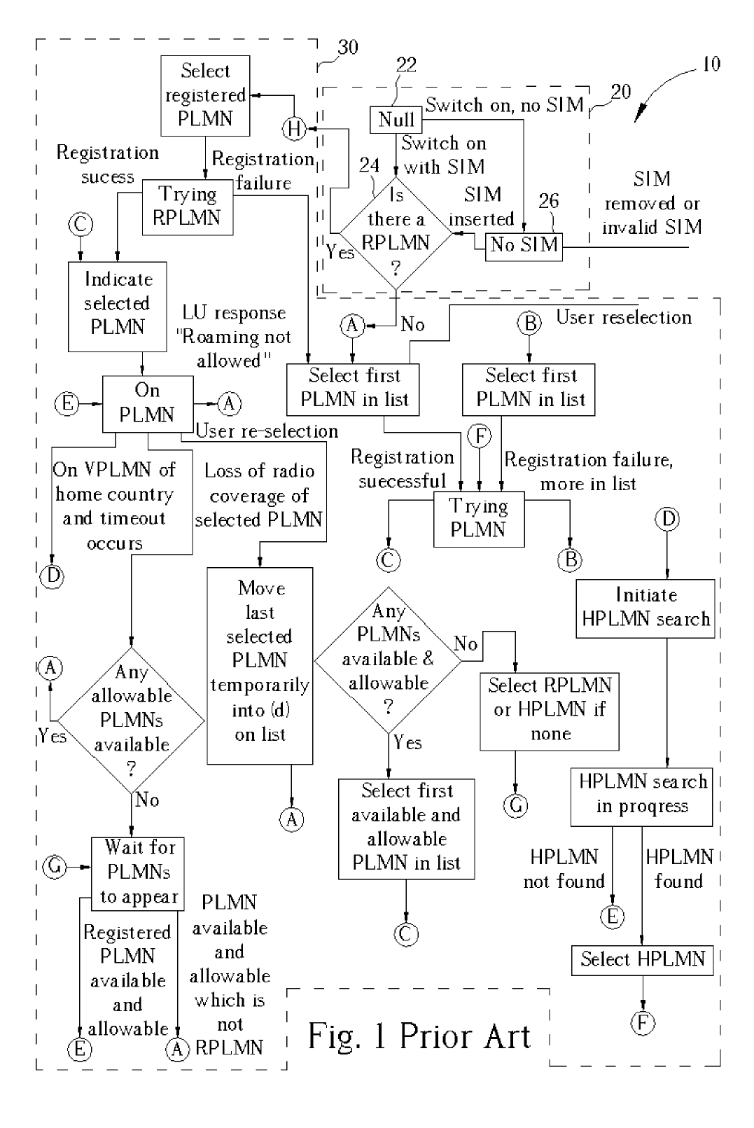

In order to allow a user with an existing GSM mobile station or a special purpose wireless device to receive free public information broadcasting services from mobile phone networks operating in the area of the user, a small change in the GSM PLMN selection state diagram shown in FIG. 1 needs to be made to allow for situations in which no valid SIM card is used.

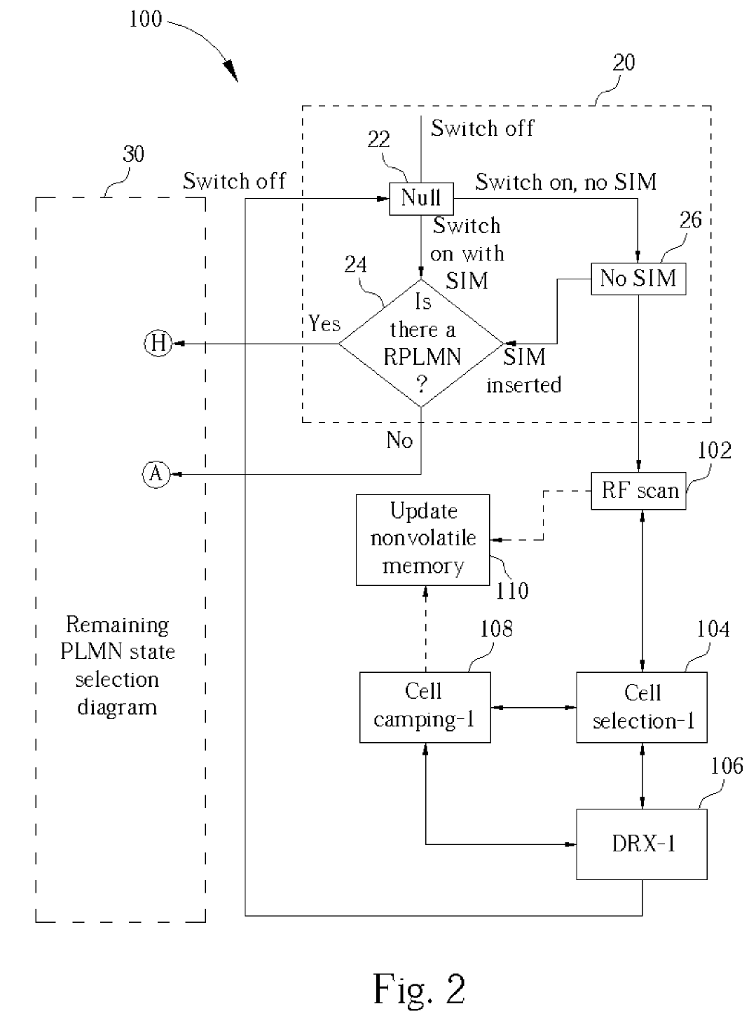

Please refer to FIG. 2. FIG. 2 is a state diagram 100 according to the present invention, and is a modification of the GSM PLMN selection state diagram shown in FIG. 1. Like the PLMN selection state diagram 10 of FIG. 1, the state diagram 100 shown in FIG. 2 also contains section 20 and section 30. In addition, the state diagram 100 also adds additional logic (shown in states 102 to 110) that is an additional branch in the state diagram starting at state 26. The additional logic added only affects mobile stations that do not have a valid SIM card, and will otherwise not affect the GSM protocol.

Since FIG. 2 takes a SIM card into consideration, FIG. 2 is provided to show the process of allowing a GSM compatible mobile station to receive free public information broadcasting services.

Section 20 begins with a null state 22 in which the mobile station is powered off. When the mobile station is switched on and contains a valid SIM card, the flow moves to state 24. Having a valid SIM card means that the SIM card can be used with a local telephone service. State 24 determines whether there is an RPLMN. If so, the flow moves to indicator arrow H in section 30. If there is no RPLMN, the flow moves to indicator arrow A in section 30. From the null state, if the mobile station is powered on and either does not contain a SIM card or does not contain a valid SIM card, the flow moves to state 26.

In the prior art state diagram shown in FIG. 1, the only way to advance beyond state 26 was to insert a valid SIM card. However, with the state diagram shown in FIG. 2, a valid SIM card is not necessary, and the flow automatically transitions to state 102. States 102 to 108 introduce four new states, which are an RF scan state 102, a cell selection-1 state 104, a DRX-1 state 106, and a cell camping-1 state 108. In addition, an implicit update nonvolatile memory state 110 is also shown in FIG. 2, as will be described below. The “-1” appended to the names of the cell selection-1 state 104, the DRX-1 state 106, and the cell camping-1 state 108 signifies that these states have different meanings than the customary meanings of these state names. For example, these three states are only used for providing downlink services to the mobile station, and therefore does not need to send any information or registration data to any of the mobile phone networks.

After the state diagram in FIG. 2 transitions from state 26 to the RF scan state 102, the mobile station will perform an RF scan on the entire RF spectrum to identify all the possible Broadcast Control Channels (BCCHs). If the mobile station is only capable of communicating on one or a few frequency bands, then the mobile station can restrict its RF scan to those frequency bands that it is able to communicate on. Instead of performing an RF scan every time the mobile station enters the RF scan state 102, the mobile station can instead access RF scan information stored in a nonvolatile memory of the mobile station. If RF scan information is already available in the nonvolatile memory, the mobile station will load this information instead of performing the RF scan. On the other hand, if an RF scan is performed, the mobile station will then briefly go to the update nonvolatile memory state 110, sort a list of the BCCHs in decreasing order of strongest average RSSI levels, store the sorted list in the nonvolatile memory, and transition back to the RF scan state 102. Having successfully loaded RF scan information, the mobile station will then transition into the cell selection-1 state 104.

Based on the results of the RF scan state 102, in the cell selection-1 state 104 the mobile phone will choose a cell corresponding to the BCCH with the strongest average RSSI level to camp on. Even after selecting the cell, the mobile station will continue to monitor a subset of the BCCHs and perform RSSI level averaging calculations. A simple path loss algorithm is used to ensure that the mobile station will always listen to a BCCH channel that provides the strong averaging RSSI signals. The subset of BCCHs will not be directly derived from the camping cell's BCCH Allocation (BA) List. Instead, the subset of BCCHs will be derived from the union of the strongest BCCHs that belong to different operators. In other words, the BA list will be derived from the strongest BCCHs that belong to different MCCs and MNCs.

After the mobile station has completed the cell selection-1 state 104, the mobile station then proceeds to the cell camping-1 state 108. In the cell camping-1 state 108, no location registration is needed as long as the mobile station does not have any path loss issues. In this state, the mobile station will try to listen to part of the system information and information broadcast from SMS channels for receiving free public information broadcasting services. Camping on multiple BCCHs is possible if these BCCHs belong to different MCCs and MNCs. While in the cell camping-1 state 108, if the average RSSI level of the selected BCCH changes by more than a threshold value while the mobile station is camping on the corresponding cell, the mobile station will automatically proceed to the update nonvolatile memory state 110, update the list of the BCCHs, and then transition back to the cell camping-1 state 108. The update nonvolatile memory state 110 is an implicit state, meaning that the mobile station will automatically roll back to the previous state after the nonvolatile memory has been updated.

The DRX-1 state 106 is similar to a typical Discontinuous Reception (DRX) mode that is used for allowing mobile stations to save power. Normally the mobile phone network specifies DRX parameters for the mobile station. However, in the DRX-1 state 106, the parameters can set to be anything the manufacturer or user wishes since the mobile station is not registered with the mobile phone network. The main important point of the DRX-1 state 106 is that the mobile station needs to be configured to include SMS scheduling broadcasting parameters so that the mobile station can still receive free public information broadcasting services. If the mobile station is switched off while in the DRX-1 state 106, the mobile station returns to the null state 22.

The state diagram shown in FIG. 2 shows how a mobile station without a valid SIM card can be used to receive free public information broadcasting services. However, there are also other applications that could benefit from free public information broadcasting services offered by mobile phone network operators.

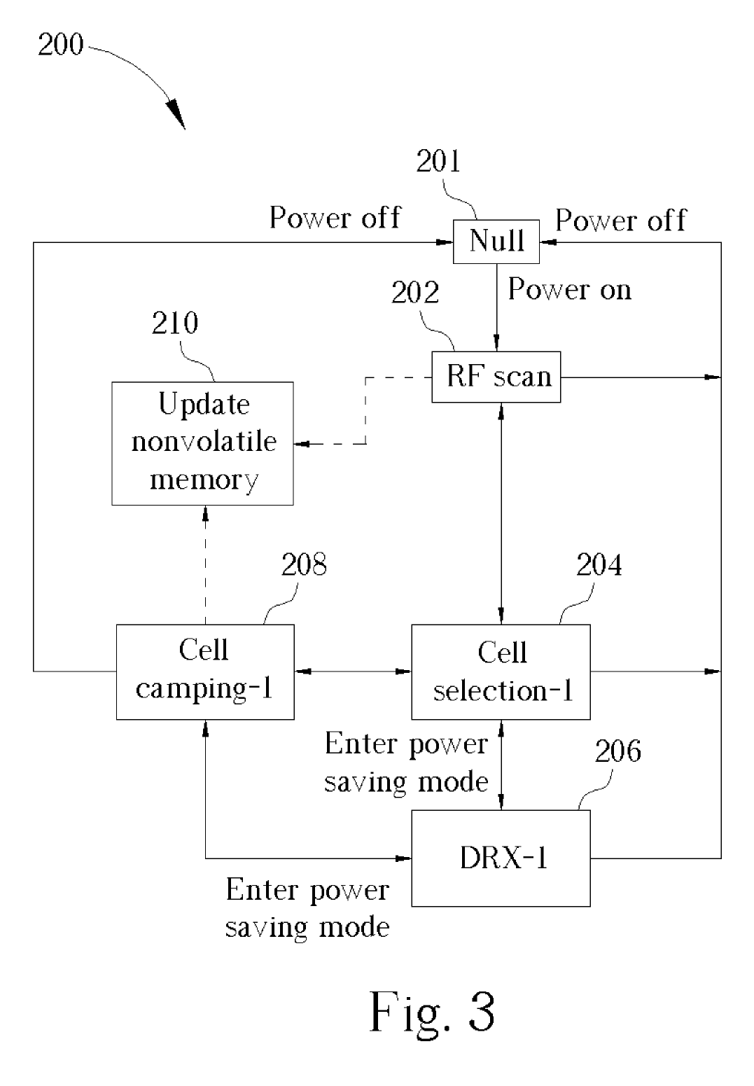

Please refer to FIG. 3. FIG. 3 contains a state diagram 200 showing how special purpose wireless devices can take advantage of the free public information broadcasting services offered by mobile phone network operators. These special purpose wireless devices may only utilize the downlink services provided, and therefore do not need to register with the mobile phone networks. Some simplified wireless devices maybe designed for location service applications. For example, a driving navigation device may use a GPS receiver to receive real-time location coordinate information from satellites. It is also possible to design a special purpose device that can triangulate its position based on measured RSSI level values. Thus, it is feasible to design a downlink-only GSM wireless device to perform certain applications such as location service and public broadcasting only applications. The downlink-only wireless device will only receive signals from base stations, and will not transmit any signals to the base stations.

Functions of the states shown in FIG. 3 have all already been described in detail with reference to FIG. 2, and will only be described again briefly. In FIG. 3, the wireless device is initially powered off, and is in a null state 201. Once powered on, the wireless device proceeds to an RF scan state 202 for scanning all possible BCCHs. Based on the results of the RF scan state 202, the wireless device then transitions to a cell selection-1 state 204 for choosing a cell to camp on. Once a cell to camp on has been selected, the wireless device proceeds to a cell camping-1 state 208. As before, the RF scan state 202 and the cell camping-1 state 208 may involve an implicit update nonvolatile memory state 210. For allowing the wireless device to save power, the wireless device can also enter a DRX-1 state 206. When the wireless device is powered off, the wireless device then goes back to the null state 201.

Although the above discussion has shown how GSM compatible mobile stations and wireless device can take advantage of free public information broadcasting services offered by GSM mobile phone network operators, other communication protocols such as CDMA could also be used in a similar way.

In contrast to the prior art, the present invention method does not require a mobile station with a valid SIM to be used in order to receive free public information broadcasting services offered by mobile phone network operators. Instead, any compatible mobile station or wireless device can be used, even without a valid SIM card or without any SIM card. Furthermore, with the present invention method, mobile stations and wireless devices can receive public broadcast services from any participating mobile phone network operator, no matter if the users of the mobile stations and wireless devices subscribe to the mobile phone network or not. In this way, users can receive important location specific public broadcasts anywhere they travel without having to subscribe to additional mobile phone networks.

Those skilled in the art will readily observe that numerous modifications and alterations of the device may be made while retaining the teachings of the invention. Accordingly, the above disclosure should be construed as limited only by the metes and bounds of the appended claims.

1. A method for receiving public broadcast services with a wireless device compatible with the Global System for Mobile communications (GSM) protocol, the method comprising:
performing a radio frequency (RF) scan on all frequencies in at least one predetermined frequency band to identify all possible Broadcast Control Channels (BCCHs);
measuring Received Signal Strength Indicator (RSSI) levels for each BCCH, and sorting the BCCHs according to the corresponding RSSI levels;
the wireless device selecting a BCCH having a strongest average RSSI level;
the wireless device camping on a cell corresponding to the selected BCCH; and
the wireless device receiving GSM public broadcast services from a mobile phone network operating the selected BCCH irrespective of whether the wireless device subscribes to the mobile phone network.

2. The method of claim 1 wherein if the wireless device is a multi-band device capable of receiving signals in a plurality of frequency bands, the wireless device scans all frequencies in each of the plurality of frequency bands for identifying all possible BCCHs.

3. The method of claim 1 wherein the wireless device comprises a nonvolatile memory, and the wireless device performs the RF scan on all frequencies in at least one predetermined frequency band if no BCCH RSSI level information is already stored in the nonvolatile memory.

4. The method of claim 3 wherein if BCCH RSSI level information is already stored in the nonvolatile memory, the wireless device loads the BCCH RSSI level information and selects a BCCH having a strongest average RSSI level.

5. The method of claim 3 wherein after measuring the RSSI levels for each BCCH and sorting the BCCHs according to the corresponding RSSI levels, the wireless device stores a list of the sorted BCCHs and the corresponding RSSI levels in the nonvolatile memory.

6. The method of claim 5 wherein the wireless device is capable of updating the list of the sorted BCCHs and the corresponding RSSI levels in the nonvolatile memory if the average RSSI level of the selected BCCH changes by more than a threshold value while the wireless device is camping on the cell corresponding to the selected BCCH.

7. The method of claim 1 wherein after the wireless device selects the BCCH having the strongest average RSSI level, the wireless device continues to monitor a subset of the identified BCCHs having a highest average RSSI level to ensure that the wireless device always selects the BCCH with the strongest average RSSI level.

8. The method of claim 1 wherein the wireless device is capable of camping on multiple BCCHs simultaneously if the multiple BCCHs each belong to different Mobile Country Codes (MCCs) and/or Mobile Network Codes (MNCs).

9. The method of claim 1 wherein the GSM public broadcast services include Short Message Service (SMS) messages sent to wireless devices by mobile phone networks.

10. A method for receiving GSM public broadcast services with a mobile station compatible with the Global System for Mobile communications (GSM) protocol, the method comprising:
searching for a Subscriber Identity Module (SIM) card in the mobile station;
determining that the mobile station does not contain a SIM card or that the mobile station contains a SIM card that cannot provide local telephone service;
performing a radio frequency (RF) scan on all frequencies in at least one predetermined frequency band to identify all possible Broadcast Control Channels (BCCHs);
measuring Received Signal Strength Indicator (RSSI) levels for each BCCH, and sorting the BCCHs according to the corresponding RSSI levels;
the mobile station selecting a BCCH having a strongest average RSSI level;
the mobile station camping on a cell corresponding to the selected BCCH; and
the mobile station receiving GSM public broadcast services from a mobile phone network operating the selected BCCH irrespective of whether the mobile station subscribes to the mobile phone network.

11. The method of claim 10 wherein if the mobile station is a multi-band device capable of receiving signals in a plurality of frequency bands, the mobile station scans all frequencies in each of the plurality of frequency bands for identifying all possible BCCHs.

12. The method of claim 10 wherein the mobile station comprises a nonvolatile memory, and the mobile station performs the RF scan on all frequencies in at least one predetermined frequency band if no BCCH RSSI level information is already stored in the nonvolatile memory.

13. The method of claim 12 wherein if BCCH RSSI level information is already stored in the nonvolatile memory, the mobile station loads the BCCH RSSI level information and selects a BCCH having a strongest average RSSI level.

14. The method of claim 12 wherein after measuring the RSSI levels for each BCCH and sorting the BCCHs according to the corresponding RSSI levels, the mobile station stores a list of the sorted BCCHs and the corresponding RSSI levels in the nonvolatile memory.

15. The method of claim 14 wherein the mobile station is capable of updating the list of the sorted BCCHs and the corresponding RSSI levels in the nonvolatile memory if the average RSSI level of the selected BCCH changes by more than a threshold value while the mobile station is camping on the cell corresponding to the selected BCCH.

16. The method of claim 10 wherein after the mobile station selects the BCCH having the strongest average RSSI level, the mobile station continues to monitor a subset of the identified BCCHs having a highest average RSSI level to ensure that the mobile station always selects the BCCH with the strongest average RSSI level.

17. The method of claim 10 wherein the mobile station is capable of camping on multiple BCCHs simultaneously if the multiple BCCHs each belong to different Mobile Country Codes (MCCs) and/or Mobile Network Codes (MNCs).

18. The method of claim 10 wherein the mobile station is in Discontinuous Reception (DRX) mode, the mobile station is capable of receiving the GSM public broadcast services.

19. The method of claim 10 wherein the GSM public broadcast services include Short Message Service (SMS) messages sent to mobile stations by mobile phone networks.
